(19) United States
(12) Patent Application Publication
(10) Pub. No.: US 2018/0158348 A1
(43) Pub. Date: Jun. 7, 2018

(54) Instructive Writing Instrument

(71) Applicant: Google LLC, Mountain View, CA (US)

(72) Inventors: Vinay Venkataraman, Sunnyvale, CA (US); Eric Aboussouan, Campbell, CA (US); David Frakes, Redwood City, CA (US)

(21) Appl. No.: 15/800,006

(22) Filed: Oct. 31, 2017

Related U.S. Application Data
(60) Provisional application No. 62/430,514, filed on Dec. 6, 2016.

(51) Int. Cl. G09B 5/02; B43K 29/08; B43K 29/10; B43K 29/00

(52) U.S. Cl. CPC G09B 5/02; B43K 29/004; B43K 29/10; B43K 29/08

(57) ABSTRACT

Systems and methods for providing instructional guidance relating to an instructive writing instrument are provided. For instance, a first visual contextual signal instructing a user to actuate an instructive writing instrument in a first direction can be provided based at least in part on a model object. The model object can correspond to an object to be rendered on a writing surface by a user using the instructive writing instrument. A first image depicting the writing surface can be obtained. First position data associated with the instructive writing instrument can be determined based at least in part on the first image. A second visual contextual signal instructing the user to actuate the instructive writing instrument in a second direction can be provided based at least in part on the model object and the first position data associated with the instructive writing instrument.

### PRIORITY CLAIM

The present application claims the benefit of priority of U.S. Provisional Application Ser. No. 62/430,514 titled Instructive Writing Assistant, filed on Dec. 6, 2016, which is incorporated herein by reference for all purposes.

### FIELD

The present disclosure relates generally to systems and methods for implementing instructive writing instruments.

### BACKGROUND

Writing is a very important form of human communication. Writing can allow an individual to express their thoughts and emotions, and to share information with the world. Having the ability to write alphabets, word, and eventually sentences is an important skill for an individual to possess. Children are typically taught to write using various assistive tools, such as stencils, etc. However, such assistive tools may not provide a natural writing experience, and users of such tools may become reliant on the assistive characteristics of the tools. In particular, such assistive tools may not allow a user to develop the muscle memory involved in learning to write.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of providing visual guidance associated with a writing instrument. The method includes providing, by one or more computing devices, a first visual contextual signal instructing a user to actuate an instructive writing instrument in a first direction based at least in part on a model object. The model object corresponds to an object to be rendered on a writing surface by a user using the instructive writing instrument. The method further includes obtaining, by one or more computing devices, a first image depicting the writing surface. The method further includes determining, by the one or more computing devices, first position data associated with the instructive writing instrument based at least in part on the first image. The method further includes providing, by the one or more computing devices, a second visual contextual signal instructing the user to actuate the instructive writing instrument in a second direction based at least in part on the model object and the first position data associated with the instructive writing instrument.

Other example aspects of the present disclosure are directed to systems, apparatus, tangible, non-transitory computer-readable media, user interfaces, memory devices, and electronic devices for providing instructional writing guidance to a user.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for providing instructional guidance related to an instructive writing instrument according to example embodiments of the present disclosure;

FIG. 2 depicts an example instructive writing instrument according to example embodiments of the present disclosure;

FIG. 3 depicts a flow diagram of an example method of providing instructional guidance according to example embodiments of the present disclosure;

FIG. 4 depicts a flow diagram of an example method of determining position data associated with an instructive writing instrument according to example embodiments of the present disclosure;

FIG. 5 depicts a flow diagram of an example method of providing instructional guidance according to example embodiments of the present disclosure; and

FIG. 6 depicts an example system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to systems and methods for providing instructional guidance to facilitate a rendering of objects on a writing surface by an instructive writing instrument. For instance, a user associated with the instructive writing instrument can provide a user input indicative of a request for instructional guidance related to the rendering of an object on a writing surface. The instructive writing instrument can provide visual contextual signals to the user instructing the user to actuate the instructive writing in one or more particular manners to facilitate a production of the object based at least in part on a model object corresponding to the object selected by the user on the writing surface. In this manner, the location and/or trajectory of the instructive writing instrument can be tracked as the user actuates the instructive writing instrument with respect to the writing surface. Updated visual contextual signals can be provided to the user based at least in part on the tracked location and trajectory of the instructive writing instrument to facilitate the rendering of the object on the writing surface.

More particularly, the user input can be any suitable user input. For instance, the user input can be a voice input, such as a voice command indicative of a model object for which instructional guidance is to be provided. In this manner, the voice command can be interpreted, and data indicative of the model object can be obtained based at least in part on the interpreted voice command. As used herein, a model object can be any suitable object that can be rendered on a writing surface by way of an actuation of a writing instrument. For instance, a model object can be a letter, number, word, phrase, sentence, character, shape, figure, structure, or any other suitable object. The model object can be associated with any suitable language. The data indicative of the model object can include model trajectory data associated with the model object. The model trajectory data can indicate a pattern (or path) to be followed by the instructive writing instrument to produce or render an object corresponding to the model object on the writing surface. Such pattern can correspond to a pattern to be followed by the instructive writing instrument to produce a rendering of the selected object on the writing surface.

The instructive writing instrument can be any suitable writing instrument, such as a pencil, pen, marker, crayon, etc. In some implementations, the instructive writing instrument can include one or more processing devices and one or more memory devices configured to implement example aspects of the present disclosure.

A plurality of images can be obtained depicting the writing surface. For instance, the images can be obtained by one or more image capture devices implemented within or otherwise associated with the instructive writing instrument. The one or more image capture devices can be disposed proximate a writing tip of the instructive writing instrument. In particular, the one or more image capture devices can be arranged such that an image captured by the image capture device depicting the writing surface can correspond to a location of the writing tip with respect to the writing surface. In some implementations, a physical contact between the writing tip and the writing surface can be detected. The plurality of images can be captured, for instance, during one or more time periods wherein such physical contact is detected. The image capture devices can be configured to capture a sequence of images as the user actuates the instructive writing instrument. In this manner, the sequence of images can correspond to different positions of the instructive writing instrument as the instructive writing instrument is actuated.

The plurality of images can be used to track the location of the instructive writing instrument with respect to the writing surface. As indicated, such location can correspond particularly to a location of the writing tip with respect to the writing surface. In some implementations, the location can be tracked by extracting one or more features from the images and determining an optical flow associated with the one or more features with respect to the sequence of images. The optical flow can specify a displacement of the extracted features between two or more of the images. For instance, the optical flow can specify a displacement with respect to a coordinate system (e.g. x, y coordinate system) associated with the writing surface. The location of the instructive writing instrument can be determined based at least in part on the determined optical flow.

As an example, a first image can be captured depicting the writing surface while the instructive writing surface is at a first location with respect to the writing surface. The user can then actuate the instructive writing instrument in some direction (e.g. while the writing tip is physically contacting the writing surface). In this manner, the user can produce a marking on the writing surface. A second image can be obtained while the instructive writing instrument is at a second location with respect to the writing surface. In this manner, the second image can be captured from a different perspective with respect to the writing surface relative to the first image. One or more features can be extracted from the first image using one or more suitable feature extraction techniques or other suitable computer vision techniques. The extracted features can be any suitable features associated with the writing surface. In some implementations, the extracted features can be associated with one or more markings on the writing surface provided by the instructive writing instrument. The extracted features can be identified in the second image (e.g. using one or more suitable feature matching techniques), and an optical flow can be determined indicative of a displacement of the extracted features in the second image relative to the first image. A location of the instructive writing instrument can be determined based at least in part on the optical flow. The determined location can be associated with a displacement of the instructive writing instrument from a time when the first image was capture to the time that the second image was captured. In this manner, a trajectory of the instructive writing instrument can be determined based at least in part on the optical flow.

In some implementations, the position data (e.g. the location and/or trajectory of the instructive writing instrument can be determined based at least in part on one or more position sensors implemented within or otherwise associated with the instructive writing instrument. The one or more position sensors can include any suitable position sensors, such as one or more accelerometers, gyroscopes, inertial measurement units, or other suitable position sensors. In this manner, the position sensors can obtain sensor data associated with the instructive writing instrument as the instructive writing instrument moves with respect to the writing surface. In some implementations, the position data can be determined based at least in part on the optical flow and the sensor data.

According to example aspects of the present disclosure, one or more visual contextual signals can be provided to the user to guide the user in actuating the instructive writing instrument in a pattern corresponding to the pattern associated with the model object. In this manner, the visual contextual signal can be any suitable signal indicating a direction in which to actuate the instructive writing instrument. For instance, a visual contextual signal can be an illumination of one or more lighting elements. The one or more lighting elements can be light emitting diodes (LEDs) or other suitable lighting elements. In some implementations, the one or more lighting elements can be located on the instructive writing instrument. In particular, the lighting elements can be arranged with respect to the instructive writing instrument, such that an illumination of one or more of the lighting elements can indicate a direction in which to actuate the instructive writing instrument. For instance, the one or more lighting elements can be evenly spaced around a body of the instructive wiring instrument, such that the lighting elements are visible to the user when the writing tip is in contact with the writing surface and the user is writing on the writing surface.

In some implementations, the visual contextual signals can include one or more haptic feedback signals that provide guidance to the user in actuating the instructive writing instrument. For instance, such haptic feedback signals can include any suitable vibration signal, force signal, motion signal, applied pressure, etc. applied by the instructive writing instrument. For instance, the haptic feedback signal(s) can be provided by one or more haptic feedback motors or devices (e.g. vibration motor, linear resonant actuator, etc.) implemented within the instructive writing instrument. In some implementations, the visual contextual signals can include one or more auditory signals that provide guidance to the user in actuating the instructive writing instrument. Such auditory signals can be output by one or more audio output devices associated with the instructive writing instrument.

The visual contextual signals can be determined based at least in part on the position data (e.g. the location of the instructive writing instrument and/or a trajectory of the instructive writing instrument with respect to the writing surface) and the data indicative of the model object (e.g. the model trajectory data). For instance, once the data indicative of the model object is obtained, a first visual contextual signal can be provided to the user (e.g. by illuminating one or more first lighting elements). The first visual contextual signal can indicate a first direction in which to actuate the instructive writing instrument to initiate a rendering of the selected object. In some implementations the first visual contextual signal can be provided in response to a detection of physical contact between the writing surface and the instructive writing instrument (e.g. the writing tip). In some implementations, an initial image can be captured by the one or more image capture devices in response to detecting the physical contact. In this manner, the user can place the writing tip at some position on the writing surface to effectuate a provision of the first visual contextual signal.

The user can then actuate the instructive writing element in the direction specified by the first visual contextual signal. For instance, if the model object is the letter “N,” the first visual contextual signal can indicate a direction of straight upwards relative to the writing surface in accordance with the letter “N.” As the user actuates the instructive writing instrument in accordance with the first visual contextual signal, a plurality of images can be captured depicting the writing surfaces from different perspectives. In some implementations, the images can be captured on a periodic basis. In some implementations, the images can be captured in response to a detection of movement by the instructive writing instrument (e.g. based on the sensor data associated with the position sensors). The position data associated with the instructive writing instrument can be determined based at least in part on the captured images.

The position data can be compared to the data indicative of the model object (e.g. the model trajectory data) to determine if the instructive writing instrument is sufficiently following the appropriate path associated with the model object. When the instructive writing instrument reaches a point corresponding to a change in direction specified by the model trajectory data, a second visual contextual signal can be provided to the user (e.g. by illuminating one or more second lighting elements) indicative of the change in direction. In this manner, the second visual contextual signal can specify a new direction in which to actuate the instructive writing instrument. For instance, in continuing the above example, when the user reaches the apex of the letter “N,” (e.g. when the user has moved the instructive writing instrument straight upwards a sufficient amount), the second visual contextual signal can be provided specifying a diagonal direction of down and to the right relative to the writing surface in accordance with the letter “N.” When the user has actuated the instructive writing instrument a sufficient amount in this direction, a third visual contextual signal can be provided to the user specifying a direction of straight upwards relative to the writing surface. In some implementations, when the user has completed the actuation pattern associated with the object, a visual contextual signal can be provided to the user indicating such completion.

In this manner, the visual contextual signals can provide instructional guidance to the user indicative of an actuation pattern to be followed by the instructive writing instrument to render the selected object on the writing surface. In some implementations, if the user actuates the instructive writing instrument in a manner that deviates from the model trajectory data by some threshold amount, a visual contextual signal can be provided to the user indicative of the deviation. For instance, in some implementations one or more course-correcting visual contextual signal can be provided specifying one or more directions in which to actuate the instructive writing instrument to correct such deviation.

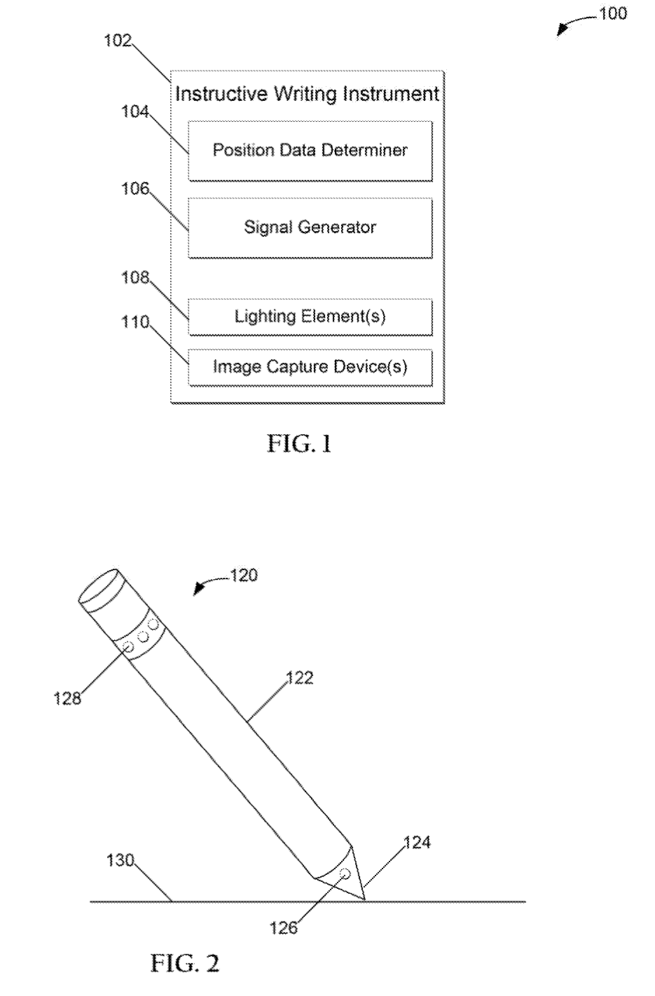

With reference now to the figures, example aspects of the present disclosure will be discussed in greater detail. For instance, FIG. 1 depicts an example system 100 for providing instructional guidance for rendering an object on a writing surface according to example embodiments of the present disclosure. System 100 includes an instructive writing instrument 102. Instructive writing instrument 102 includes a position data determiner 104 and a signal generator 106. As will be described in more detail with regard to FIG. 2, the instructive writing instrument 102 can be any suitable writing instrument. The instructive writing instrument 102 can include a writing tip. In some implementations, the writing tip can be capable of applying a writing medium on a writing surface.

The position data determiner 104 can be configured to determine a location of the instructive writing instrument 102 with respect to the writing surface. For instance, the position data determiner 104 can obtain a plurality of images captured by one or more image capture devices 110. The image capture devices 110 can be positioned on the instructive writing instrument 102. For instance, the image capture devices 110 can be positioned proximate the writing tip of the instructive writing instrument 102. In some implementations, the image capture devices 110 can be arranged with respect to the instructive writing instrument such that, when the writing tip is making physical contact with the writing surface, the field of view of the image capture devices 110 includes at least a portion of the writing surface. More particularly, the image capture devices 110 can be arranged such that images captured by the image capture devices 110 while the writing tip is in contact with the writing surface can correspond to a location of the instructive wiring instrument 102 with respect to the writing surface. In this manner, such images captured by the image capture devices 110 can depict at least a portion of the writing surface, and can be indicative of the location of the instructive writing instrument and/or the writing tip relative to the writing surface.

The plurality of images captured by the image capture devices 110 can depict the writing surface from different perspectives. For instance, the plurality of images can be captured as the instructive writing instrument 102 is in relative motion with the writing surface. As an example, a first image can be captured while the instructive writing instrument 102 is located at a first position with respect to the writing surface. A second image can be captured while the instructive writing instrument 102 is located at a second position with respect to the writing surface. The second image can depict the writing surface from a different perspective than the first image.

The position data determiner 104 can perform one or more feature matching techniques to match features between two or more of the obtained images. For instance, the position data determiner 104 can identify one or more suitable features depicted in a first image, and can identify one or more corresponding features depicted in a second image. The one or more corresponding features can be features depicted in the second image that are also depicted in the first image. Because the second images is associated with a different perspective than the first image, the one or more corresponding features can be located in a different position within the second image than the in the first image. The position data determiner 104 can determine an optical flow associated with the one or more corresponding features to quantify a displacement of the features in the second image relative to the first image. The position data determiner 104 can further determine position data of the instructive writing instrument 102 based at least in part on the determined optical flows. More particularly, the position data determiner 104 can determine a location of the instructive writing instrument 102 with respect to the writing surface based at least in part on the optical flows. The position data determiner 104 can further determine a trajectory of the instructive writing instrument 102 based at least in part on the optical flows.

The position data associated with the instructive writing instrument 102 can be used to instruct and/or guide the a user in actuating the instructive writing instrument 102 based at least in part on trajectory data associated with a model object. For instance, the user can specify an object for which guidance is to be provided through use of a suitable user input. For instance, the user input can be a voice command, touch input, gesture, input using a suitable input device (e.g. keyboard, mouse, touchscreen, etc.), or other suitable input. In implementations wherein the input is a voice command, the instructive writing instrument can interpret the voice command to identify the requested object. The instructive writing instrument can then obtain data indicative of a model object corresponding to the requested object. For instance, the data indicative of the model object can include trajectory data defining one or more patterns or paths to follow to correctly produce the requested object on a writing surface.

The instructive writing instrument 102 can provide one or more visual contextual signals to the user to guide the user in actuating the instructive writing instrument in a suitable manner to render the requested object on the writing surface. The visual contextual signals can indicate directions in which the user is to actuate the instructive writing instrument to follow the trajectory data associated with the model object. The visual contextual signals can be an illumination of one or more lighting elements (e.g. LEDs) that indicate a suitable direction to follow. In this manner, the signal generator can provide a visual contextual signal by causing an illumination of one or more suitable lighting elements indicating an appropriate direction. In some implementations, the visual contextual signals can include other suitable signals indicating an appropriate direction to follow or other suitable instruction. Such other suitable signals can be provided in addition to or instead of the illumination of the lighting elements. For instance, such other suitable signals can include auditory signals (e.g. vocal instructions), text instructions, haptic feedback signals or other suitable signals.

The visual contextual signals can be determined based at least in part on the model object data and the position data associated with the instructive writing instrument. For instance, the signal generator 106 can compare the position data against the model trajectory data to determine if the instructive writing instrument is sufficiently following the model trajectory. The signal generator 106 can generate and provide the visual contextual signals based at least in part on the comparison. For instance, the signal generator 106 can provide a first visual contextual signal (e.g. by illuminating one or more first lighting elements) to prompt the user to actuate the instructive writing instrument 102 in a first direction corresponding to a first direction specified by the model trajectory data. The position data determiner 104 can track the position and/or trajectory of the instructive writing instrument 102 as the user actuate the instructive writing instrument 102 in accordance with the first visual contextual signal. In some implementations, the first visual contextual signal can be continuously provided as the user actuates the instructive writing instrument 102 in the first direction. When the instructive writing instrument 102 reaches a position corresponding to a direction change specified by the model trajectory data, the signal generator 106 can determine a second visual contextual signal based at least in part on the model trajectory data. The second visual contextual signal can prompt the user to actuate the instructive writing instrument 102 in a second direction. In this manner, the signal generator 106 can provide the second visual contextual signal by illuminating one or more second lighting elements indicative of the second direction.

Such process can be repeated for one or more additional direction changes specified by the model trajectory data. In this manner, the position data determiner 104 can determine updated position data as the user actuates the instructive writing instrument in accordance with the visual contextual signals, and the signal generator 106 can determine and provide one or more additional visual contextual signals based on the updated position data and the model trajectory data. When the user completes the actuation of the instructive writing instrument in accordance with the model trajectory data, one or more visual contextual signals can be provided indicative of such completion.

In some implementations, the signal generator 106 can provide the visual contextual signals during one or more time periods when the writing tip of the instructive writing instrument 102 is in physical contact with the writing surface. For instance, the instructive writing instrument 102 can be configured to detect such contact using one or more sensors. In this manner, the user can initiate the instructional guidance process by placing the writing tip on the writing surface. In response to the detection of such placement, an initial image can be captured by the image capture devices 110. The signal generator 106 can then determine a visual contextual signal based at least in part on the model object data, and can provide the visual contextual signal to the user. If the user removes the writing tip from the writing surface for some threshold period of time, the process can be stopped or paused, and the signal generator 106 can cease providing the visual contextual signals to the user. In some implementations, the process can then be resumed once the user places the writing tip back on the writing surface (e.g. at the point where the user removed the writing tip).

Although FIG. 1 depicts the position data determiner 104 and the signal generator 106 as being implemented within the instructive writing instrument, it will be appreciated that functionality associated with at least one of the position data determiner 104 and the signal generator 106 can be performed by one or more remote computing devices from the instructive writing instrument. For instance, in such implementations, the instructive writing instrument 102 can be configured to communicate with such remote computing device(s) (e.g. over a network) to implement example aspects of the present disclosure.

FIG. 2 depicts an example instructive writing instrument 120 according to example embodiments of the present disclosure. The instructive writing instrument 120 can correspond to the instructive writing instrument 102 depicted in FIG. 1 or other instructive writing instrument. The instructive writing instrument 120 can be any suitable writing instrument, such as a pen, pencil, marker, crayon, chalk, brush, etc. As shown the instructive writing instrument 120 can include a generally elongated body 122 and a writing tip 124. The instructive writing instrument 120 can be configured to be gripped by a hand of a user, such that the user can apply a writing medium to a writing surface 130. In this manner, the instructive writing instrument 120 can store a writing medium that can be applied to the writing surface 130 via the writing tip 124. Such writing medium can include lead, graphite, ink, paint, etc. The writing surface 130 can be any suitable writing surface, such as a sheet of paper or other suitable surface.

The instructive writing instrument 120 can include one or more image capture devices 126. The image capture devices 126 can be any suitable image capture devices. Such image capture devices can be configured to capture images depicting at least a portion of the writing surface 130, for instance, as the instructive writing instrument 120 is in relative motion with the writing surface 130. As shown the image capture devices 126 are positioned proximate the writing tip 124. More particularly, the image capture devices 126 can be positioned such that, when the instructive writing instrument 120 is positioned such that the writing tip 124 is in contact with the writing surface 130, the field of view of the image capture devices 126 includes at least a portion of the writing surface 130. In this manner, such field of view can correspond to a position of the instructive writing instrument 120 with respect to the writing surface 130.

The instructive writing instrument 120 can further include lighting elements 128. The lighting elements 128 can be LEDs or other suitable lighting elements. The lighting elements 128 can be positioned, such that an illumination of one or more of the lighting elements 128 can indicate a direction in which to actuate the instructive writing instrument. For instance, the lighting elements 128 can be positioned such that, when the user is gripping the instructive writing instrument 120, and the instructive writing instrument 120 is in contact with the writing surface 130, the lighting elements 128 are visible to the user. In some implementations, the lighting elements 128 can be spaced around a circumference of the body 122. As shown, the lighting elements 128 can be positioned in a ring about the body 122.

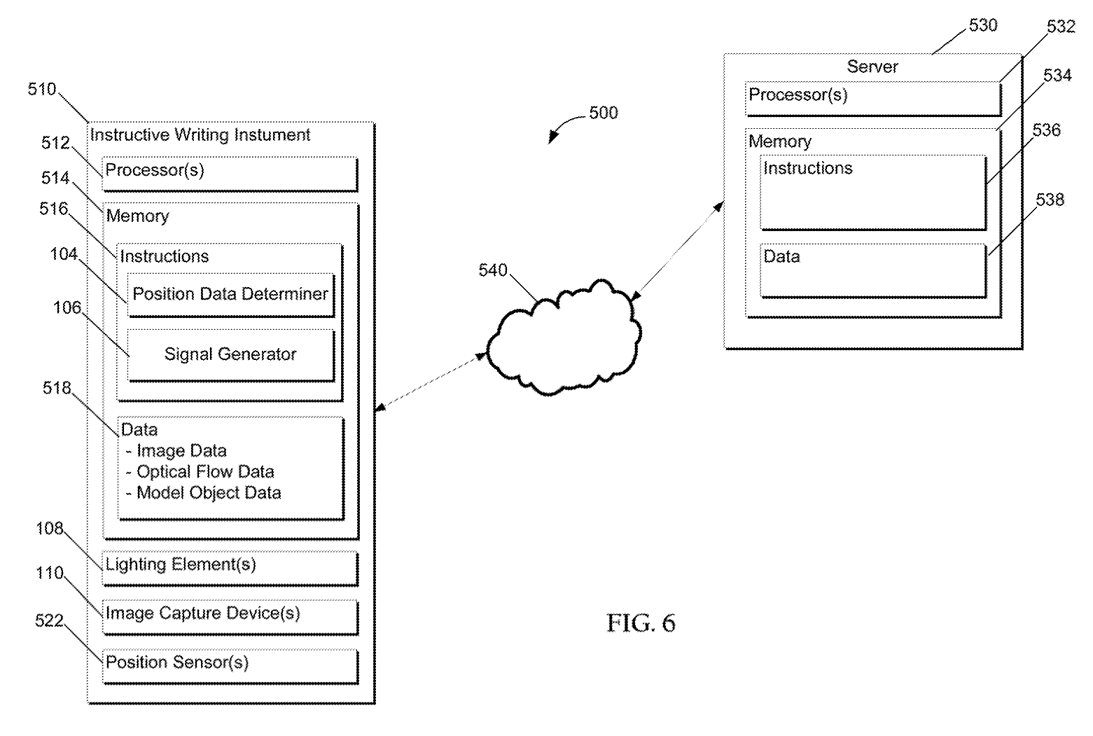

As will be described in more detail with respect to FIG. 6, the instructive writing instrument 120 can include one or more processing devices and one or more memory devices configured implement example aspects of the present disclosure. For instance, such processing devices and memory devices can be configured to implement the position data determiner 104 and/or the signal generator 106 depicted in FIG. 1.

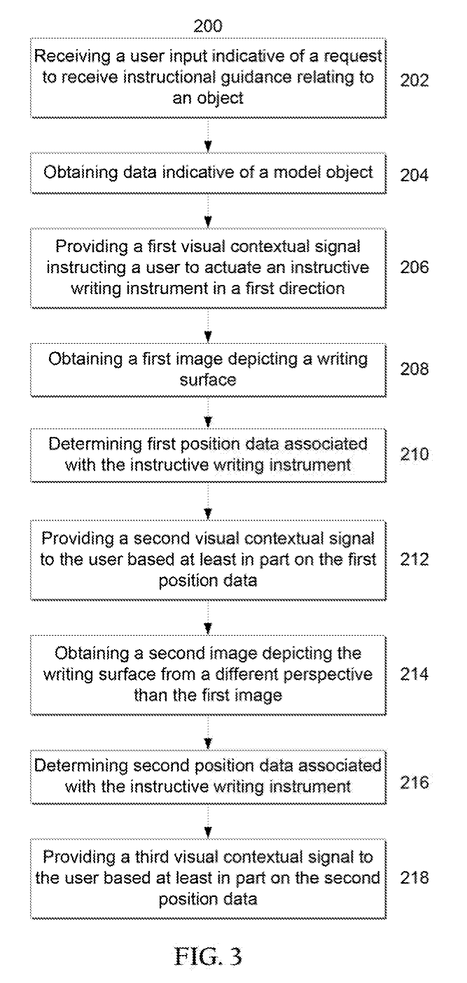

FIG. 3 depicts a flow diagram of an example method (200) of providing instructional guidance to a user relating to an actuation of a writing instrument according to example embodiments of the present disclosure. The method (200) can be implemented by one or more computing devices, such as one or more of the computing devices depicted in FIG. 6. In particular implementations, the method (200) can be implemented by the position data determiner 104 and the signal generator 106 depicted in FIG. 1. In addition, FIG. 3 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (202), the method (200) can include receiving a user input indicative of a request to receive instructional guidance relating to an object. For instance, a user can interact with one or more computing devices to request such instructional guidance associated with the requested object. For instance, such user input can be a voice command or other suitable user input indicative of such request. The requested object can be any suitable object, such as a letter, word, character, number, punctuation mark, phrase, sentence, item, drawing, etc. The requested object can be associated with any suitable language.

At (204), the method (200) can include obtaining data indicative of a model object based at least in part on the user input. For instance, the model object can correspond to the requested object. The data indicative of the model object can include trajectory data or other data specifying a path or pattern to be followed with respect to a writing surface to render the object on the writing surface.

At (206), the method (200) can include providing a first visual contextual signal instructing the user to actuate the instructive writing instrument in a first direction. For instance, the first direction can be determined based at least in part on the model object data. More particularly, the first direction can correspond to a first direction associated with the model trajectory data associated with the model object. The first visual contextual signal can be an illumination of one or more lighting elements associated with the instructive writing instrument indicative of the first direction. In some implementations, the first visual contextual signal can be provided in response to a detection of physical contact between the instructive writing instrument and the writing surface.

At (208), the method (200) can include obtaining a first image depicting the writing surface from a first perspective. The first image can be captured by an image capture device associated with the instructive writing instrument.

At (210), the method (200) can include determining first position data associated with the instructive writing instrument. The first position data can include a first location of the instructive writing instrument with respect to the writing surface and/or a first trajectory associated with the instructive writing instrument with respect to the writing surface. The trajectory can correspond to an actuation of the instructive writing instrument by the user relative to the writing surface.

At (212), the method (200) can include providing a second visual contextual signal to the user based at least in part on the first position data and/or the model object data. For instance, the second visual contextual signal can be indicative of a second direction in which the instructive writing instrument is to be actuated. Such second direction can correspond to a direction change specified by the model trajectory data. The second visual contextual signal can be an illumination of one or more second lighting elements associated with the instructive writing instrument indicative of the second direction. In this manner, the second visual contextual signal can be provided in response to the instructive writing instrument reaching a point with respect to the writing surface corresponding to a direction change specified by the model object data.

At (214), the method (200) can include obtaining a second image depicting the writing surface from a different perspective than the first image. The second image can be captured by the image capture device associated with the instructive writing instrument.

At (216), the method (200) can include determining second position data associated with the instructive writing instrument based at least in part on the second image. For instance, the second position data can include a second location of the instructive writing instrument with respect to the writing surface and/or a second trajectory associated with the instructive writing instrument with respect to the writing surface. The second position data can be updated position data relative to the first position data. In this manner, the second location and/or the second trajectory can be different than the first location and/or the first trajectory.

At (218), the method (200) can include providing a third visual contextual signal to the user based at least in part on the second position data. For instance, the third visual contextual signal can be indicative of a third direction in which the instructive writing instrument is to be actuated. The third visual contextual signal can correspond to a direction change specified by the model object data. In this manner, the third visual contextual signal can be provided in response to the instructive writing instrument reaching a point with respect to the writing surface corresponding to the direction change specified by the model object data.

As indicated, one or more additional visual contextual signals can be provided based on updated position data and the model object data as the user actuates the instructive writing instrument in accordance with the visual contextual signals. In this manner, such additional visual contextual signals can be provided to facilitate a completion of the actuation of the instructive writing instrument in the manner specified by the model trajectory data.

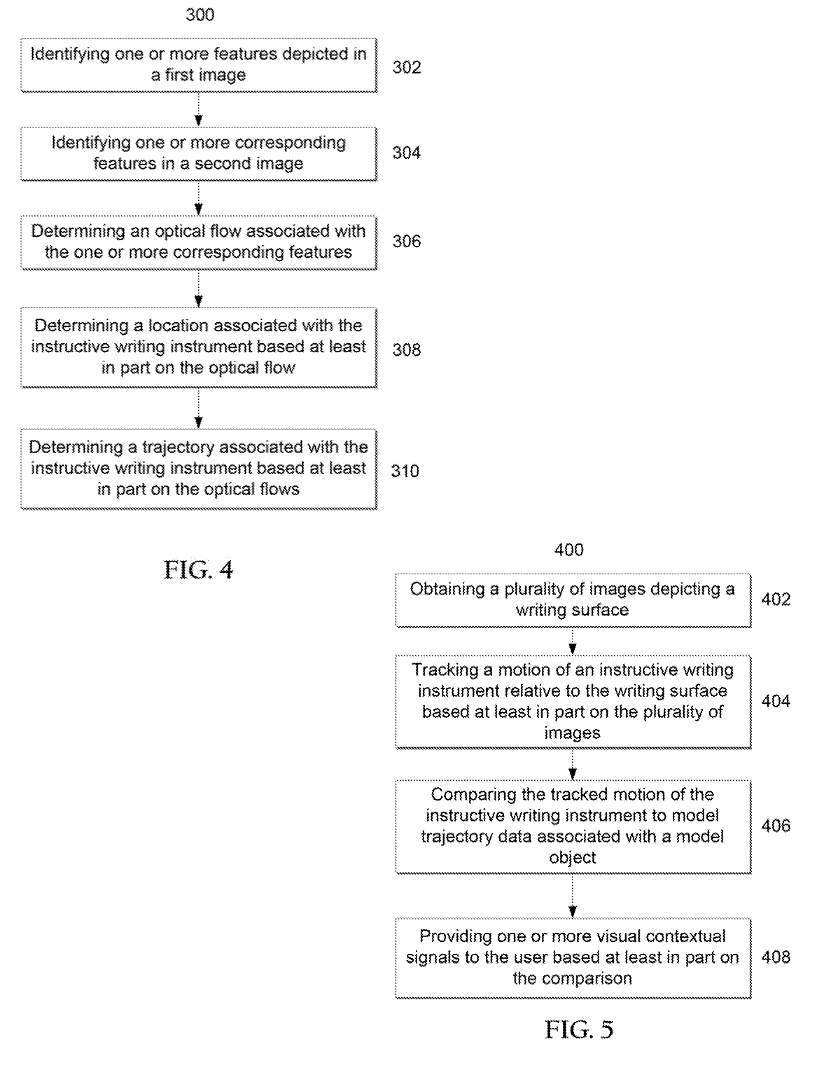

FIG. 4 depicts a flow diagram of an example method (300) of determining position data according to example embodiments of the present disclosure. The method (300) can be implemented by one or more computing devices, such as one or more of the computing devices depicted in FIG. 6. In particular implementations, the method (300) can be implemented by the position data determiner 104 depicted in FIG. 1. In addition, FIG. 4 depicts steps performed in a particular order for purposes of illustration and discussion.

At (302), the method (300) can include identifying one or more features depicted in a first image. The first image can be captured by an image capture device associated with an instructive writing instrument. The first image can correspond to a location of the instructive writing instrument relative to a writing surface. In this manner, the first image can depict at least a portion of the writing surface from a first perspective. The one or more features can be features associated with the writing surface as depicted in the first image. The one or more features can be identified using one or more feature extraction techniques.

At (304), the method (300) can include identifying one or more corresponding features in a second image. The second image can depict at least a portion of the writing surface from a second perspective that is different than the first perspective. The second image can depict one or more of the identified features from the first image from the second perspective. Such corresponding features can be identified using one or more feature matching techniques or other suitable computer vision techniques.

At (306), the method (300) can include determining an optical flow associated with the one or more corresponding features. The optical flow can specify a displacement of the corresponding features in the second image relative to the first image. The optical flows can be determined using any suitable optical flow determination technique.

At (308), the method (300) can include determining a location associated with the instructive writing instrument with respect to the writing surface based at least in part on the optical flows associated with the corresponding features. The location, for instance, can be defined by a coordinate system associated with the images and/or the writing surface.

At (310), the method (300) can include determining a trajectory associated with the instructive writing instrument based at least in part on the determined location and/or the optical flows. The trajectory can be associated with an actuation of the instructive writing instrument by the user with respect to the writing surface.

FIG. 5 depicts a flow diagram of an example method (400) of providing visual contextual signals to a user instructing a user to actuate a writing instrument. The method (400) can be implemented by one or more computing devices, such as one or more of the computing devices depicted in FIG. 6. In particular implementations, the method (400) can be implemented by the position data determiner 104 and/or the signal generator 106 depicted in FIG. 1. In addition, FIG. 5 depicts steps performed in a particular order for purposes of illustration and discussion.

At (402), the method (400) can include obtaining a plurality of images depicting a writing surface. The images can be captured by one or more image capture devices associated with an instructive writing instrument. The images can depict the writing surface from a plurality of different perspectives. In this manner, the images can be captured as a user actuates the instructive writing instrument with respect to the writing surface.

At (404), the method (400) can include tracking a motion of an instructive writing instrument relative to the writing surface based at least in part on the plurality of images. For instance, tracking the motion of the instructive writing instrument can include determining a plurality of locations of the instructive writing instrument based at least in part on the images. Tracking the motion of the instructive writing instrument can further include determining a plurality of trajectories of the instructive writing instrument based at least in part on the images. In this manner, the manner in which the instructive writing instrument is moved relative to the writing surface can be determined over one or more periods of time.

At (406), the method (400) can include comparing the tracked motion of the instruction writing instrument to data indicative of a model object (e.g. trajectory data). For instance, the model object data can specify one or more patterns or paths to be followed to render an object corresponding to the model object on the writing surface. The tracked motion of the instructive writing instrument can be compared to the model object data to determine a correspondence between the model object data and the manner in which the user has actuated the instructive writing instrument.

At (408), the method (400) can include providing one or more visual contextual signals to the user based at least in part on the comparison. The visual contextual signals can prompt the user to actuate the instructive writing instrument in one or more directions based at least in part on the model object data. In this manner, as the user is actuating the instructive writing instrument, the visual contextual signals can be provided to prompt the user to follow a path corresponding to the model object data. In some implementations, the visual contextual signals can correspond to a change in direction of the instructive writing instrument. In this manner, the visual contextual signals can guide the user in actuating the instructive writing instrument in accordance with the model object.

FIG. 6 depicts an example computing system 500 that can be used to implement the methods and systems according to example aspects of the present disclosure. The system 500 can be implemented using a client-server architecture that includes an instructive writing instrument 510. In some implementations, the instructive writing instrument 510 can communicate with one or more servers 530 over a network 540. The system 500 can be implemented using other suitable architectures, such as a single computing device.

The system 500 includes an instructive writing instrument 510 The instructive writing instrument 510 can be any suitable writing instrument. The instructive writing instrument 510 can be implemented using any suitable computing device(s). The instructive writing instrument 510 can have one or more processors 512 and one or more memory devices 514. The instructive writing instrument 510 can also include a network interface used to communicate with one or more servers 530 over the network 540. The network interface can include any suitable components for interfacing with one more networks, including for example, transmitters, receivers, ports, controllers, antennas, or other suitable components.

The one or more processors 512 can include any suitable processing device, such as a microprocessor, microcontroller, integrated circuit, logic device, graphics processing units (GPUs) dedicated to efficiently rendering images or performing other specialized calculations, or other suitable processing device. The one or more memory devices 514 can include one or more computer-readable media, including, but not limited to, non-transitory computer-readable media, RAM, ROM, hard drives, flash drives, or other memory devices. The one or more memory devices 514 can store information accessible by the one or more processors 512, including computer-readable instructions 516 that can be executed by the one or more processors 512. The instructions 516 can be any set of instructions that when executed by the one or more processors 512, cause the one or more processors 512 to perform operations. For instance, the instructions 516 can be executed by the one or more processors 512 to implement one or more modules, such as the position data determiner 104 and the signal generator 106 described with reference to FIG. 1.

As shown in FIG. 6, the one or more memory devices 514 can also store data 518 that can be retrieved, manipulated, created, or stored by the one or more processors 512. The data 518 can include, for instance, image data generated according to example aspects of the present disclosure, optical flow data determined according to example aspects of the present disclosure, model object data, and other data. The data 518 can be stored locally at the instructive writing instrument 510, or remotely from the instructive writing instrument 510. For instance, the data 518 can be stored in one or more databases. The one or more databases can be connected to the instructive writing instrument 510 by a high bandwidth LAN or WAN, or can also be connected to instructive writing instrument 510 through network 540. The one or more databases can be split up so that they are located in multiple locales.

The instructive writing instrument 510 can include, or can otherwise be associated with, various input/output devices for providing and receiving information from a user, such as a touch screen, touch pad, data entry keys, speakers, and/or a microphone suitable for voice recognition. For instance, the instructive writing instrument can include one or more image capture devices 110 and one or more lighting elements 108 for presenting visual contextual signals according to example aspects of the present disclosure. The instructive writing instrument can further include one or more position sensors 522 configured to monitor a location of the instructive writing instrument 510.

The instructive writing instrument 510 can exchange data with one or more servers 530 over the network 540. Any number of servers 530 can be connected to the instructive writing instrument 510 over the network 540. Each of the servers 530 can be implemented using any suitable computing device(s).

Similar to the instructive writing instrument 510, a server 530 can include one or more processor(s) 532 and a memory 534. The one or more processor(s) 532 can include one or more central processing units (CPUs), and/or other processing devices. The memory 534 can include one or more computer-readable media and can store information accessible by the one or more processors 532, including instructions 536 that can be executed by the one or more processors 532 and data 538.

The server 530 can also include a network interface used to communicate with one or more remote computing devices (e.g. instructive writing instrument 510) over the network 540. The network interface can include any suitable components for interfacing with one more networks, including for example, transmitters, receivers, ports, controllers, antennas, or other suitable components.

The network 540 can be any type of communications network, such as a local area network (e.g. intranet), wide area network (e.g. Internet), cellular network, or some combination thereof. The network 540 can also include a direct connection between a server 530 and the instructive writing instrument 510. In general, communication between the instructive writing instrument 510 and a server 530 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of providing visual guidance associated with a writing instrument, the method comprising:
providing, by one or more computing devices, a first visual contextual signal instructing a user to actuate an instructive writing instrument in a first direction based at least in part on a model object, the model object corresponding to an object to be rendered on a writing surface by a user using the instructive writing instrument;
obtaining, by one or more computing devices, a first image depicting the writing surface;
determining, by the one or more computing devices, first position data associated with the instructive writing instrument based at least in part on the first image; and
providing, by the one or more computing devices, a second visual contextual signal instructing the user to actuate the instructive writing instrument in a second direction based at least in part on the model object and the first position data associated with the instructive writing instrument.

2. The computer-implemented method of claim 1, further comprising:
receiving, by the one or more computing devices, a user input indicative of the model object to be rendered by the user on a writing surface using an instructive writing instrument; and
accessing, by the one or more computing devices, data indicative of the model object.

3. The computer-implemented method of claim 2, wherein providing, by one or more computing devices, a first visual contextual signal comprises providing the first visual contextual signal subsequent to accessing the data indicative of the model object.

4. The computer-implemented method of claim 1, further comprising detecting, by the one or more computing devices, a physical contact between a writing tip of the writing instrument and the writing surface.

5. The computer-implemented method of claim 4, wherein:
providing, by one or more computing devices, a first visual contextual signal comprises providing the first visual contextual signal responsive to detecting the physical contact between the writing tip of the writing instrument and the writing surface; and
providing, by one or more computing devices, a second visual contextual signal comprises providing the second visual contextual signal responsive to detecting the physical contact between the writing tip of the writing instrument and the writing surface.

6. The computer-implemented method of claim 1, further comprising:
obtaining, by one or more computing devices, a second image depicting the writing surface;
determining, by the one or more computing devices, second position data associated with the instructive writing instrument based at least in part on the second image; and
providing, by the one or more computing devices, a third visual contextual signal instructing the user to actuate the instructive writing instrument in a third direction based at least in part on the model object and the second position data associated with the instructive writing instrument.

7. The computer-implemented method of claim 1, wherein determining, by the one or more computing devices, first position data comprises:
extracting, by the one or more computing devices, one or more features from the first image;
determining, by the one or more computing devices, an optical flow associated with the one or more extracted features.

8. The computer-implemented method of claim 1, wherein determining by the one or more computing device, first position data comprises determining the first position data based at least in part on one or more position sensors associated with the instructive writing instrument.

9. The computer-implemented method of claim 1, wherein the first image is captured by one or more image capture devices integrated with the instructive writing instrument.

10. The computer-implemented method of claim 1, wherein the first and second visual contextual signals comprise lighting signals provided by one or more lighting elements integrated with the instructive writing instrument.

11. The computer-implemented method of claim 10, wherein providing, by one or more computing devices, a first visual contextual signal comprises:
determining, by the one or more computing devices, one or more first lighting elements to be illuminated based at least in part on the model object; and
causing, by the one or more computing devices, the one or more first lighting elements to illuminate.

12. The computer-implemented method of claim 11, wherein providing, by one or more computing devices, a second visual contextual signal comprises:
determining, by the one or more computing devices, one or more second lighting elements to be illuminated based at least in part on the model object and the first position data; and
causing, by the one or more computing devices, the one or more second lighting elements to illuminate.

13. The computer-implemented method of claim 1, wherein the first position data comprises a first location associated with the writing instrument and a first trajectory associated with the writing instrument.

14. The computer-implemented method of claim 1, wherein the instructive writing instrument is a pen, pencil, marker, or crayon.

15. A computing system, comprising:
one or more processors; and
one or more memory devices, the one or more memory devices storing computer-readable instructions that when executed by the one or more processors cause the one or more processors to perform operations, the operations comprising:
providing a first visual contextual signal instructing a user to actuate an instructive writing instrument in a first direction based at least in part on a model object, the model object corresponding to an object to be rendered on a writing surface by a user using the instructive writing instrument;
obtaining a first image depicting the writing surface;
determining first position data associated with the instructive writing instrument based at least in part on the first image; and
providing a second visual contextual signal instructing the user to actuate the instructive writing instrument in a second direction based at least in part on the model object and the first position data associated with the instructive writing instrument.

16. The computing system of claim 15, the operations further comprising:
receiving a user input indicative of the model object to be rendered by the user on a writing surface using an instructive writing instrument; and
accessing data indicative of the model object based at least in part on the user input.

17. The computing system of claim 15, the operations further comprising:
obtaining a second image depicting the writing surface;
determining second position data associated with the instructive writing instrument based at least in part on the second image; and
providing a third visual contextual signal instructing the user to actuate the instructive writing instrument in a third direction based at least in part on the model object and the second position data associated with the instructive writing instrument.

18. One or more tangible, non-transitory computer-readable media storing computer-readable instructions that when executed by one or more processors cause the one or more processors to perform operations, the operations comprising:
providing a first visual contextual signal instructing a user to actuate an instructive writing instrument in a first direction based at least in part on a model object, the model object corresponding to an object to be rendered on a writing surface by a user using the instructive writing instrument;
obtaining a first image depicting the writing surface;
determining first position data associated with the instructive writing instrument based at least in part on the first image; and
providing a second visual contextual signal instructing the user to actuate the instructive writing instrument in a second direction based at least in part on the model object and the first position data associated with the instructive writing instrument.

19. The or more tangible, non-transitory computer-readable media of claim 18, the operations further comprising:
obtaining a second image depicting the writing surface;
determining second position data associated with the instructive writing instrument based at least in part on the second image; and
providing a third visual contextual signal instructing the user to actuate the instructive writing instrument in a third direction based at least in part on the model object and the second position data associated with the instructive writing instrument.

20. The or more tangible, non-transitory computer-readable media of claim 18, wherein determining, by the one or more computing devices, first position data comprises:
extracting one or more features from the first image;
determining an optical flow associated with the one or more extracted features.
